(19) United States
(12) Patent Application Publication
(10) Pub. No.: US 2005/0264508 A1
(43) Pub. Date: Dec. 1, 2005

(54) Liquid crystal display device and driving method thereof

(76) Inventors: Masashi Nakamura, Chosei (JP); Nobuhiro Takeda, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/141,040

(22) Filed: Jun. 1, 2005

(30) Foreign Application Priority Data
Jun. 1, 2004 (JP) 2004-163162

(51) Int. Cl. G09G 3/36

(52) U.S. Cl. 345/89

(57) ABSTRACT

A liquid crystal display device can have enhanced display quality of a display screen by preventing the generation of lateral stripes on the display screen when the polarity of a gray scale voltage is inverted for every N (N≧2) lines without providing a new display control signal. In the liquid crystal display device, a gray scale voltage is applied to a plurality of pixels, and the polarity of the gray scale voltage is inverted for every N (N≧2) video lines. The polarity inversion line position at which the polarity of the gray scale voltage is changed from the positive polarity to the negative polarity or vice versa different among respective frames. Thus, the polarity inversion line position is discontinuous among continuous frames. Further, the positive polarity gray scale voltage and the negative polarity gray scale voltage are supplied to the respective pixels every N/2 times.

### BACKGROUND OF THE INVENTION

The present invention relates in general to a liquid crystal display device and to a driving method thereof, and, more particularly, the invention relates to a technique which is effective when applied to an N line inversion driving method in which the polarity of a gray scale voltage applied to pixels is inverted for every plural lines.

An active matrix type liquid crystal display device, in which switching of active elements, such as thin film transistors (TFT), is carried out to produce a display, has been popularly used as a display device in a personal computer or the like.

In general, with respect to a liquid crystal layer, when the same voltage (the DC voltage) is applied to the liquid crystal layer for a long time, the inclination of the liquid crystal layer becomes fixed, and, hence, an image detention phenomenon is induced, thus shortening the lifetime of the liquid crystal layer.

To prevent such a drawback, in a liquid crystal display module, voltage applied to the liquid crystal layer is alternated for every fixed period of time, that is, using the voltage which is applied to a common electrode as a reference, a gray scale voltage, which is applied to the pixel electrodes, is alternately changed to a positive voltage side/a negative voltage side for every fixed period of time.

As a driving method in which an AC voltage is applied to the liquid crystal layer, a common symmetry method has been employed. The common symmetry method is a method in which the common voltage applied to a common electrode is set as a fixed value, and inverts the gray scale voltage applied to the pixel electrodes is inverted alternately to the positive side and the negative side using the common voltage applied to the common electrode as a reference, on which a dot inversion method, an n line (for example, 2 lines) inversion method and the like have been based.

FIG. 16 is a diagram showing the polarity of the gray scale voltage that is written in each pixel when the dot inversion method is used as the method of driving a liquid crystal display module.

In the dot inversion method, as shown in FIG. 16, for example, with respect to odd-numbered lines of an odd-numbered frame, a negative-polarity gray scale voltage (indicated by a black dot in FIG. 16), with respect to the common voltage (Vcom) applied to the common electrode, is applied to odd-numbered pixels, while a positive-polarity gray scale voltage (indicated by a white dot in FIG. 16), with respect to the common voltage (Vcom) applied to the common electrode, is applied to even-numbered pixels. With respect to even-numbered lines of the odd-numbered frame, a positive-polarity gray scale voltage is applied to the odd-numbered pixels and a negative-polarity gray scale voltage is applied to even-numbered pixels.

Further, the polarity for every line is inverted for every frame. That is, as shown in FIG. 16, with respect to the odd-numbered lines of the even-numbered frame, the positive-polarity gray scale voltage is applied to the odd-numbered pixels and the negative-polarity gray scale voltage is applied to the even-numbered pixels. With respect to the even-numbered lines of the even-numbered frame, the negative-polarity gray scale voltage is applied to the odd-numbered pixels and the positive-polarity gray scale voltage is applied to the even-numbered pixels.

In this dot inversion method, the electric current which flows into the common electrode is small, and, hence, the voltage drop is prevented from becoming large, whereby the voltage level of the common electrode is made stable and deterioration of the display quality can be suppressed to a minimum.

However, in this dot inversion method, it is necessary to discharge the drain signal line from the positive-polarity gray scale voltage to the negative-polarity gray scale voltage for every 1 line, or to charge the drain signal line from the negative-polarity gray scale voltage to the positive-polarity gray scale voltage, thus giving rise to a drawback in that the power consumption is large. This drawback can be overcome by adopting the N line (for example, 2 line) inversion method, wherein the polarity of the gray scale voltage applied to the drain signal line from the drain driver can be inverted for every N lines (see JP-A-2001-215469 (patent literature)).

However, in the case in which the N line inversion method is adopted as the driving method, as shown in FIG. 17, for example, when an image is displayed over the whole screen with the same gray scale and the same color, a lateral stripe is formed on the display screen for every N lines, thus giving rise to a drawback in that the display quality of the liquid crystal display panel is remarkably degraded.

### SUMMARY OF THE INVENTION

The above-mentioned patent literature discloses, a technique in which a gate line is set to “H” after a given time A lapses and the writing of a liquid crystal cell is stated to prevent the generation of the lateral stripes in the display screen.

However, in the technique disclosed in the above-mentioned patent literature, to set the gate line to “H” after the given time A lapses, there arises a drawback in that a new display control signal, which is referred to as an output enable signal/VOE, becomes necessary.

The present invention has been made to overcome the above-mentioned drawbacks, and it is an object of the present invention to provide a technique, for use in a liquid crystal display device and a driving method thereof, which is capable of enhancing the display quality of a display screen by preventing the generation of lateral stripes on the display screen when the polarity of a gray scale voltage is inverted for every N (N≧2) lines, without requiring the provision of a new display control signal.

The above-mentioned and other novel features of the present invention will become apparent from the description provided in this specification and the attached drawings.

A summary of typical aspects of the invention disclosed in this specification is as follows.

That is, the present invention is characterized in that, in a liquid crystal display device, when the polarity of a gray scale voltage supplied to respective video lines is inverted for every N (N≧2) lines, the polarity inversion line position where the polarity of the gray scale voltage is changed from the positive polarity to the negative polarity, or from the negative polarity to the positive polarity, is different among respective frames.

A brief explanation of advantageous effects obtained by the present invention disclosed in this specification is as follows. According to the liquid crystal display device and the driving method of the present invention, it is possible to enhance the display quality of the display screen by preventing the generation of lateral stripes on the display screen, when the polarity of a gray scale voltage is inverted for every N (N≧2) lines, without providing a new display control signal.

### BRIEF DESCRIPTION OF THE DRAWINGS

FIG. 1 is a block diagram showing the constitution of a liquid crystal display module to which the present invention is applied;

FIG. 2 is an equivalent circuit diagram showing one example of the liquid crystal display panel shown in FIG. 1;

FIG. 3 is an equivalent circuit diagram showing another example of the liquid crystal display panel shown in FIG. 1;

FIG. 4 is a block diagram showing the constitution of one example of a drain drive circuit shown in FIG. 1;

FIG. 5 is a block diagram showing the constitution of the drain driver shown in FIG. 4, with particular focus on the constitution of an output circuit;

FIG. 6 is a diagram showing the polarity of a gray scale voltage outputted to drain signal lines (D) from the drain driver when a 2 line inversion method is used as a method of driving a liquid crystal display module;

FIG. 7A and FIG. 7B are waveform timing diagrams illustrating a reason why lateral stripes are generated in a display screen when the 2 line inversion method is used as the method of driving the liquid crystal display module;

FIG. 8 is a diagram showing a summary of one example of the driving method of the present invention;

FIG. 9 is a diagram showing the polarity of the gray scale voltage written in pixels in a column A in FIG. 8 with respect to sequentially continuous frames;

FIG. 10A and FIG. 10B are diagrams showing a summary of another example of the driving method of the present invention;

FIG. 11A and FIG. 11B are diagrams showing a summary of yet another example of the driving method of the present invention;

FIG. 12A and FIG. 12B are diagrams showing a summary of still another example of the driving method of the present invention;

FIG. 13A and FIG. 13B are diagrams showing a summary of a further example of the driving method of the present invention;

FIG. 14A and FIG. 14B are diagrams showing a summary of a still further example of the driving method of the present invention;

FIG. 15 is a block diagram showing the circuit constitution of an AC signal generating circuit for generating an AC signal (M) in a liquid crystal display module representing an embodiment of the present invention;

FIG. 16 is a diagram showing the polarity of the gray scale voltage written in respective pixels when a dot inversion method is used as a driving method of a liquid crystal display module; and

FIG. 17 is a diagram showing a lateral stripe for every N lines formed on a liquid crystal display panel when an N line inversion method is adopted as the driving method.

### DETAILED DESCRIPTION OF THE INVENTION

Hereinafter, various embodiments of the present invention will be explained in detail in conjunction with the attached drawings.

Here, in all of the drawings, parts having identical functions are indicated by the same symbols, and a repeated explanation thereof is omitted.

(Basic Constitution of TFT Type Liquid Crystal Display Module to Which the Present Invention is Applied)

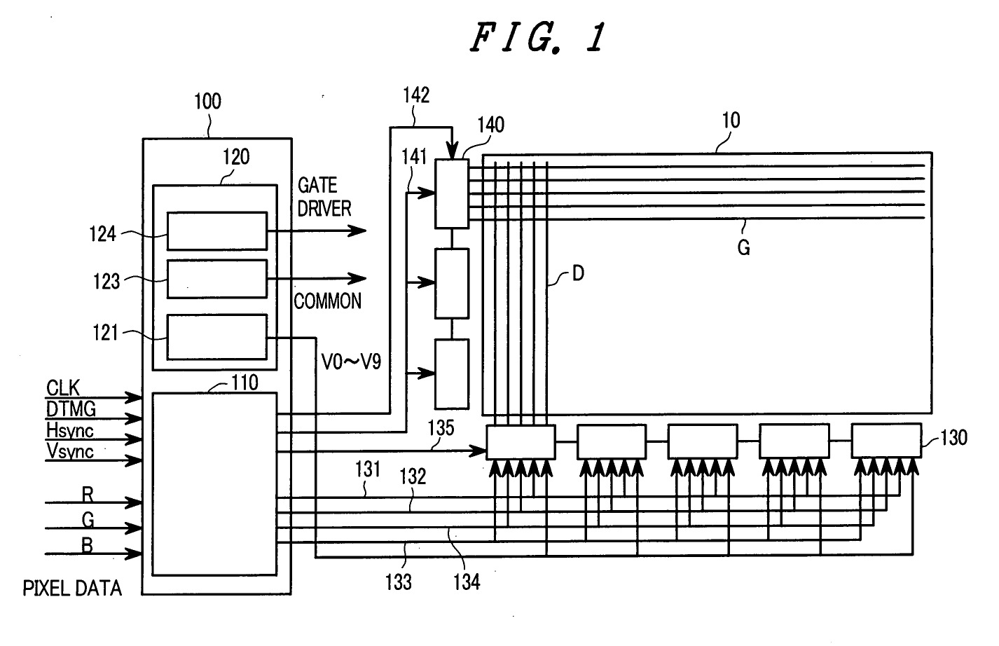

FIG. 1 is a block diagram showing the constitution of a liquid crystal display module to which the present invention is applied.

In the liquid crystal display module shown in FIG. 1, a drain driver 130 is arranged on a long side of a liquid crystal display panel 10, while a gate driver 140 is arranged on a short side of the liquid crystal display panel 10. The drain driver 130 and the gate driver 140 are directly mounted on peripheral portions of one glass substrate (for example, a TFT substrate) of the liquid crystal display panel 10.

An interface part 100 is mounted on an interface printed circuit board, and the interface printed circuit board is mounted on a back side of the liquid crystal display panel 10.

(The Constitution of Liquid Crystal Display Panel 10 Shown in FIG. 1)

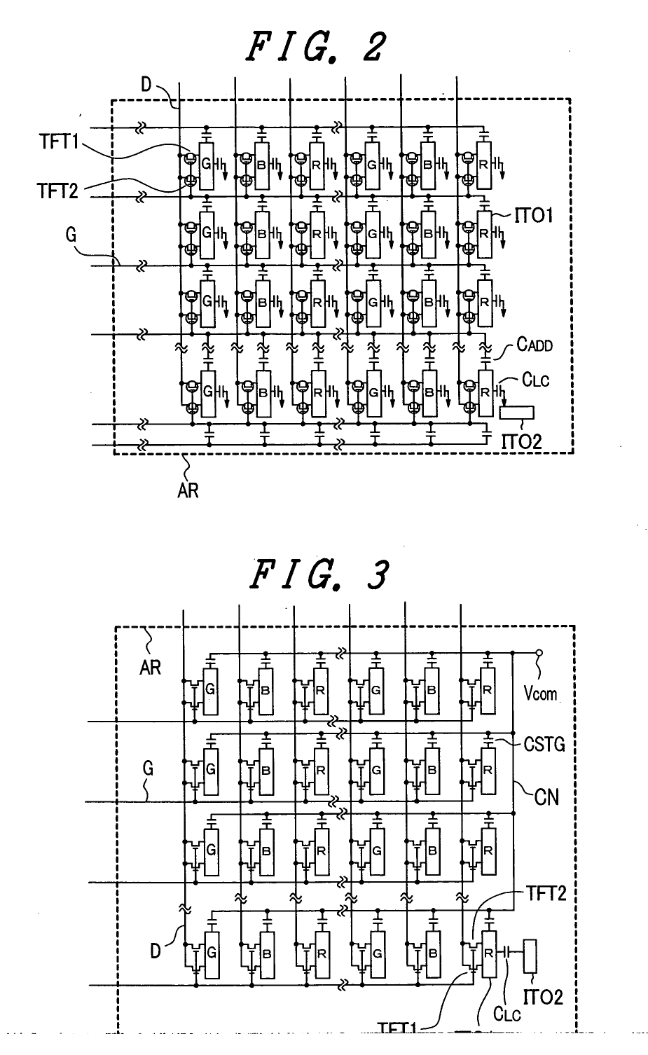

FIG. 2 is an equivalent circuit diagram showing one example of the liquid crystal display panel 10 shown in FIG. 1. As shown in FIG. 2, the liquid crystal display panel 10 includes a plurality of pixels which are formed in a matrix array.

Each pixel is arranged in the inside of a region where two neighboring signal lines (drain signal lines (D) or gate signal lines (G)) and two neighboring signal lines (gate signal lines (G) or drain signal lines (D)) intersect each other. Each pixel also includes thin film transistors (TFT1, TFT2) and source electrodes of the thin film transistors (TFT1, TFT2) of each pixel are connected with a pixel electrode (ITO1).

Further, a liquid crystal layer is formed between the pixel electrodes (ITO1) and a common electrode (ITO2), and, hence, a liquid crystal capacitance (CLC) is equivalently connected between the pixel electrodes (ITO1) and the common electrode (ITO2). Further, between source electrodes of the thin film transistors (TFT1, TFT2) and the gate signal line (G) of the preceding stage, a holding capacitance (CADD) is connected.

FIG. 3 is an equivalent circuit diagram showing another example of the liquid crystal display panel 10 shown in FIG. 1.

In the example shown in FIG. 2, a holding capacitance (CADD) is formed between the gate signal line (G) of the preceding stage and the source electrode. The equivalent circuit of the example shown in FIG. 3 differs from the equivalent circuit of the example shown in FIG. 2 with respect to the point that an additional capacitance (CSTG) is formed between a common signal line (CN) and a source electrode.

Although the present invention is applicable to both of the above-described examples, in the former method, the gate signal line (G) pulse of the preceding stage jumps into the pixel electrode (ITO1) through the holding capacitance (CADD). However, since there is no jumping in the latter method, it is possible to provide a more favorable display.

Here, FIG. 2 and FIG. 3 show the equivalent circuits of a vertical electric field type of liquid crystal display panel, wherein symbol AR indicates a display region in FIG. 2 and FIG. 3. Although FIG. 2 and FIG. 3 are circuit diagrams, in these drawings, parts are depicted so as to correspond to the actual geometric arrangements of the elements.

In the liquid crystal display panel 10 shown in FIG. 2 and FIG. 3, the drain electrodes of the thin film transistors (TFT1, TFT2) of the respective pixels, which are arranged in the column direction, are respectively connected to the drain signal lines (D), while the respective drain signal lines (D) are connected to a drain driver 130, which applies a gray scale voltage to the liquid crystal of respective pixels in the column direction.

Further, gate electrodes of the thin film transistors (TFT1, TFT2) in the respective pixels, which are arranged in the row direction, are connected with the respective gate signal lines (G), and the respective gate signal lines (G) are connected with a gate driver 140, which supplies a scanning drive voltage (a positive bias voltage or a negative bias voltage) to the gate electrodes of the thin film transistors (TFT1, TFT2) of the respective pixels in the row direction for 1 horizontal scanning time.

(The Constitution and Summary of Operation of Interface Part 100 Shown in FIG. 1)

A display control device 110, as shown in FIG. 1, is constituted of one semiconductor integrated circuit (LSI), and it controls and drives the drain driver 130 and the gate driver 140 in response to respective display control signals, consisting of an external clock signal (DCLK), a display timing signal (DTMG), a horizontal synchronizing signal (Hsync) and a vertical synchronizing signal (Vsync), and display data (R•G•B), which are transmitted from a host computer side.

The display control device 110, upon receipt the display timing signal, determines that this input designates a display start position and outputs a start pulse (a display data acquisition start signal) to the first drain driver 130 through a signal line 135; and, thereafter, it outputs the received display data of a single column to the drain driver 130 through a bus line 133 of the display data.

Here, the display control device 110 outputs a display data latch clock (CL2), which is a display control signal used for latching the display data in a data latch circuit of each drain driver 130 (hereinafter simply referred to as the clock (CL2)) through a signal line 131.

The display data transmitted from the host computer side is provided in 6 bits, for example, and it is transmitted for every unit time for every pixel unit, that is, for one set of respective data of red (R), green (G), blue (B).

Further, in response to the start pulse inputted to the first drain driver 130, the latching operation of the data latch circuit in the first drain driver 130 is controlled.

When the latching operation of the data latch circuit in the first drain driver 130 is finished, the start pulse is inputted to the second drain driver 130 from the first drain driver 130, and, hence, the latching operation of the data latch circuit in the second drain driver 130 is controlled. Hereinafter, the latching operation of the data latch circuits of the respective drain drivers 130 is controlled in the same manner, thus preventing erroneous display data from being written in the data latch circuits.

When the inputting of the display timing signal is finished or a given fixed time lapses after inputting of the display timing signal, the display control device 110 assumes that the display data for one horizontal amount is finished and outputs an output timing control clock (CL1), which is a display control signal used for outputting a gray scale voltage corresponding to the display data stored in the data latch circuit in each drain driver 130, to the drain signal lines (D) of the liquid crystal display panel 10 (hereinafter, simply referred to as the clock (CL1)) to the respective drain drivers 130 through a signal line 132.

Further, when the first display timing signal is inputted after inputting the vertical synchronizing signal, the display control device 110 determines that this signal is for the first display line and outputs a frame start instruction signal (FLM) to the gate driver 140 through the signal line 142.

Further, the display control device 110 outputs a clock (CL3), which is a shift clock of 1 horizontal scanning time cycle, to the gate driver 140 through a signal line 141, such that a positive bias voltage is applied to respective gate signal lines (G) of the liquid crystal display panel 10 sequentially for every horizontal scanning time in response to the horizontal synchronizing signal.

Due to such an operation, the plurality of thin film transistors (TFT1, TFT2) which are connected with the respective gate signal lines (G) of the liquid crystal display panel 10 become conductive during 1 horizontal scanning time. Due to the above-mentioned operations, images are displayed on the liquid crystal display panel 10.

(Constitution of the Power Source Circuit 120 Shown in FIG. 1)

The power source circuit 120 shown in FIG. 1 is constituted of a gray scale reference voltage generating circuit 121, a common electrode (counter electrode) voltage generating circuit 123 and a gate electrode voltage generating circuit 124.

The gray scale reference voltage generating circuit 121 is constituted of a serial resistance voltage-dividing circuit, and it outputs gray scale reference voltages of 10 values (V0 to V9), for example. These gray scale reference voltages (V0 to V9) are supplied to the respective drain drivers 130. Further, to the respective drain drivers 130, an AC signal (an AC timing signal; M) from the display control device 110 is also supplied through a signal line 134.

The common electrode voltage generating circuit 123 generates a common voltage (Vcom) which is applied to the common electrode (ITO2), and the gate electrode voltage generating circuit 124 generates driving voltages (a positive bias voltage and a negative bias voltage) which are applied to the gate electrodes of the thin film transistors (TFT1, TFT2).

(Constitution of the Drain Driver 130 Shown in FIG. 1)

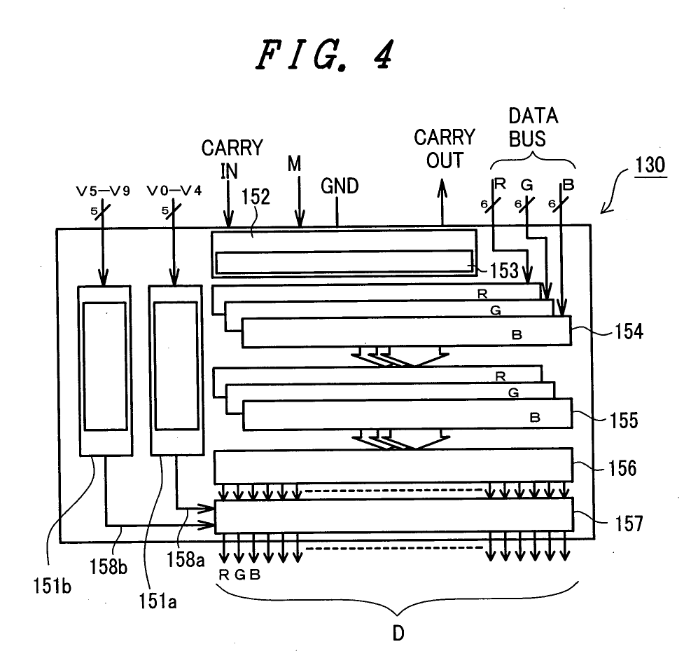

FIG. 4 is a block diagram showing the constitution of one example of the drain driver 130 shown in FIG. 1. Here, the drain driver 130 is constituted of one semiconductor integrated circuit (LSI).

As seen in the drawing, a positive-polarity gray-scale voltage generating circuit 151a generates gray scale voltages of 64 positive-polarity gray scales based on the gray scale reference voltages (V0 to V4) of 5 values which are supplied from the gray scale reference voltage generating circuits 121, and it outputs the gray scale voltages to an output circuit 157 through a voltage bus line 158a.

A negative-polarity gray-scale voltage generating circuit 151b generates gray scale voltages of 64 negative-polarity gray scales based on the gray scale reference voltages (V5 to V9) of 5 negative-polarity values, which are supplied from the gray scale reference voltage generating circuits 121, and it outputs the gray scale voltages to the output circuit 157 through a voltage bus line 158b.

Further, a shift register circuit 153 in the inside of the control circuit 152 of the drain driver 130 generates a data acquisition signal for an input register circuit 154, based on the clock (CL2) inputted from the display control device 110, and it outputs the data acquisition signal to the input register circuit 154.

The input register circuit 154 latches the display data of 6 bits for each color in synchronism with the clock (CL2) inputted from the display control device 110, based on the data acquisition signal outputted from the shift register circuit 153, by an amount corresponding to the output amount.

A storage register circuit 155 latches the display data in the inside of the input register circuit 154 in response to the clock (CL1) inputted from the display control device 110. The display data inputted to the storage register circuit 155 is inputted to the output circuit 157 through a level shift circuit 156.

The output circuit 157 selects one gray scale voltage (one gray scale voltage among 64 gray scales) corresponding to the display data, based on the gray scale voltages of 64 positive-polarity gray scales or the gray scale voltages of 64 negative-polarity gray scales, and it outputs the selected gray scale voltage to each drain signal line (D).

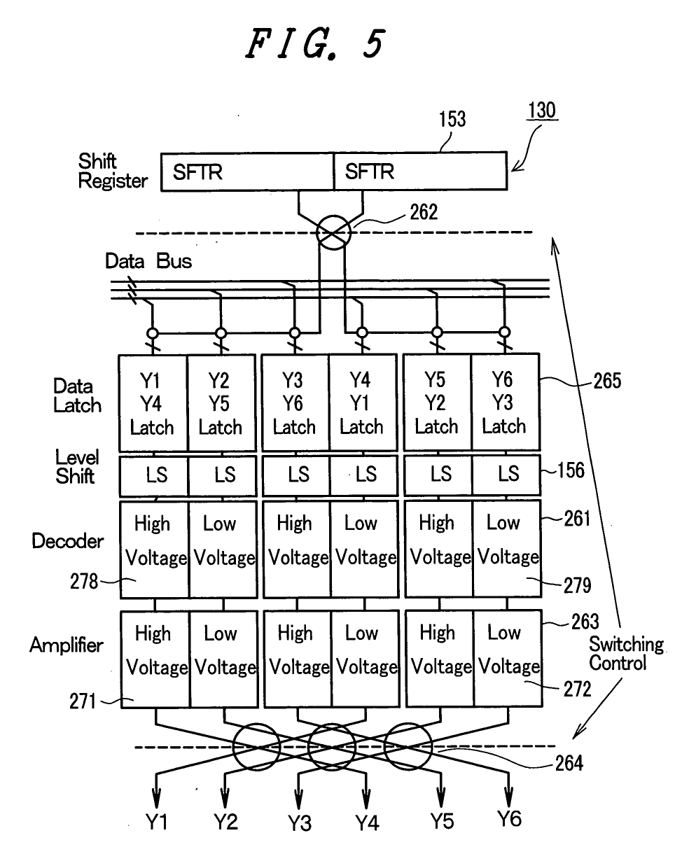

FIG. 5 is a block diagram showing the constitution of the drain driver 130 shown in FIG. 4, with particular focus on the constitution of the output circuit 157.

In the drawing, numeral 153 indicates the shift register circuit in the inside of the control circuit 152 shown in FIG. 4, numeral 156 indicates the level shift circuit shown in FIG. 4, and a data latch part 265 represents the input register circuit 154 and storage register circuit 155 shown in FIG. 4. Further, a decoder part (a gray scale voltage selection circuit) 261, a pair of amplifying circuits 263, and a switching part (2) 264, which changes over outputs of the pair of amplifying circuits 263, constitute the output circuit 157 shown in FIG. 4.

Here, a switching part (262) and the switching part (2) 264 are controlled in response to the AC signal (M). Further, Y1 to Y6 respectively indicate first to sixth drain signal lines (D).

In the drain driver 130 shown in FIG. 5, the data acquisition signal which is inputted to the data latch part 265 (to be more specific, the input register 154 shown in FIG. 4) is changed over by the switching part (1) 262 so as to input the display data for respective colors to the neighboring data latch parts 265 for respective colors.

The decoder part 261 is constituted of a high-voltage decoder circuit 278, which selects the positive-polarity gray scale voltage corresponding to the display data outputted from the respective data latch parts 265 (to be more specific, the storage register 155 shown in FIG. 4), out of the gray scale voltages of 64 positive-polarity gray scales outputted from the gray scale voltage generating circuit 151a, through a voltage bus line 158a, and a low-voltage decoder circuit 279, which selects the negative-polarity gray scale voltage corresponding to the display data outputted from the respective data latch parts 265, out of the gray scale voltages of 64 negative-polarity gray scales outputted from the gray scale voltage generating circuit 151b, through a voltage bus line 158b.

The high voltage decoder circuits 278 and the low voltage decoder circuits 279 are provided for every neighboring data latch part 265.

Each pair of amplifying circuits 263 is constituted of the high voltage amplifying circuit 271 and the low voltage amplifying circuit 272.

The positive-polarity gray scale voltages generated by the high voltage decoder circuits 278 are inputted to the high voltage amplifying circuits 271, while the high voltage amplifying circuits 271 output the positive-polarity gray scale voltages after amplifying an electric current.

The negative-polarity gray scale voltages generated by the low voltage decoder circuits 279 are inputted to the low voltage amplifying circuits 272, while the low voltage amplifying circuits 272 outputs the negative-polarity gray scale voltages after amplifying an electric current.

In the dot inversion method, the neighboring gray scale voltages of respective colors have polarities which are opposite relative to each other and the pairs of amplifying circuits 263, constituted of the high voltage amplifying circuits 271 and the low voltage amplifying circuits 272, are arranged in the order of the high voltage amplifying circuit 271→the low voltage amplifying circuit 272→the high voltage amplifying circuit 271→the low voltage amplifying circuit 272. Accordingly, by changing over the data acquisition signals inputted to the data latch parts 265 using the switching part (1) 262, the display data for respective colors is inputted to the neighboring data latch parts 265 for respective colors. In conformity with such inputting, the output voltages, which are outputted from the high voltage amplifying circuits 271 or the low voltage amplifying circuits 272, are changed over using the switching parts (2) 264, and they are outputted to the drain signal lines (Y) to which the gray scale voltages for respective colors are outputted, for example, the first drain signal line (Y1) and the fourth drain signal line (Y4), whereby it is possible to output the positive-polarity and negative-polarity gray scale voltages to the respective drain signal lines (Y).

Hereinafter, a summary of the present invention will be explained in conjunction with a case in which the 2-line inversion method is adopted as the driving method.

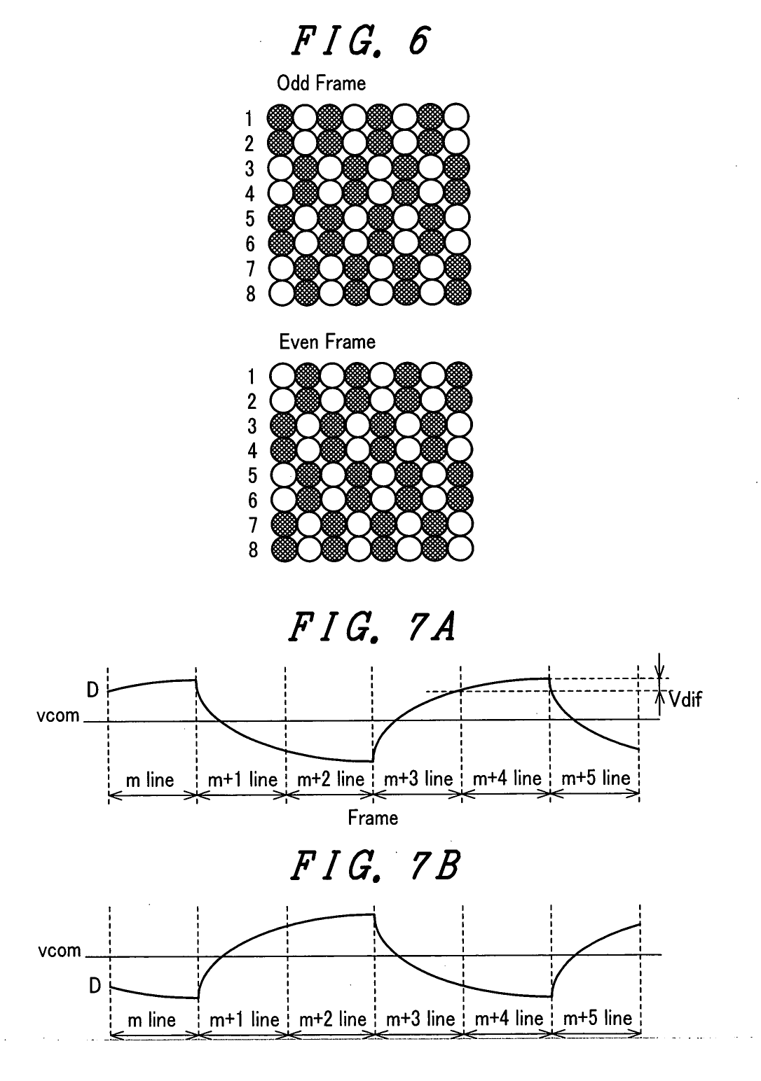

When the 2-line inversion method is adopted as the method of driving a liquid crystal display module, the polarities of the gray scale voltages which are outputted to the drain signal lines (D) from the drain driver 130 (that is, the gray scale voltages applied to the pixel electrodes) are as shown by way of example in FIG. 6. Here, in FIG. 6, the positive-polarity gray scale voltages are expressed by white dots and the negative-polarity gray scale voltages are expressed by black dots.

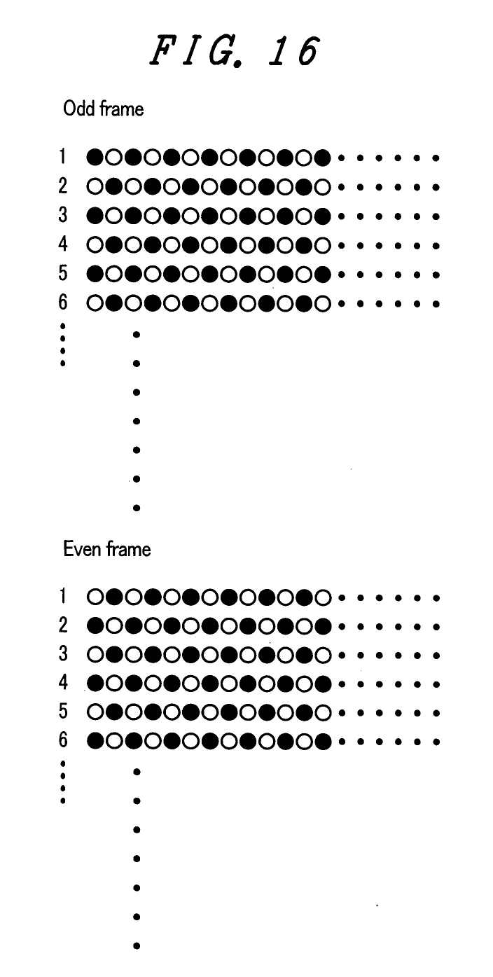

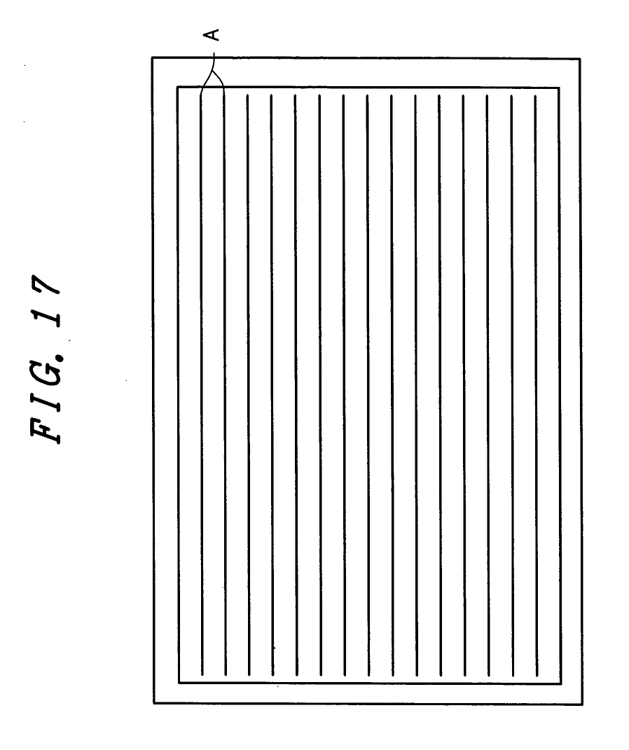

The 2-line inversion method differs from the dot inversion method shown in the above-mentioned FIG. 16 only with respect to the point that the polarities of the gray scale voltages outputted to the drain signal lines (D) from the drain driver 130 are inverted, and, hence, a detailed explanation of the 2-line inversion method is omitted. For example, when an image consisting of the same gray scales is displayed on the liquid crystal display panel 10 over several lines, in the 2-line inversion method, the drain driver 130 outputs gray scale voltages, in which the polarities are inverted for every 2 lines, to the drain signal lines (D).

Hereinafter, the reason why the above-mentioned lateral stripes are formed when the 2-line inversion method is used will be explained in conjunction with FIG. 7.

Here, a case is considered in which the polarity of the gray scale voltages, which are outputted to the drain signal lines (D), is changed from the negative polarity to the positive polarity by the drain driver 130.

In this case, the gray scale voltages on the drain signal lines (D) will assume the negative polarity before the polarity of the gray scale voltages is inverted, and they will assume the positive polarity after the polarity of the gray scale voltages is inverted. However, the drain signal lines (D) are considered as a kind of distribution constant line, and, hence, the gray scale voltages cannot be immediately changed to the positive-polarity gray scale voltages from the negative-polarity gray scale voltages; and, as indicated by voltage waveforms shown in FIG. 7, the gray scale voltages are changed to the positive-polarity gray scale voltages from the negative-polarity gray scale voltages with a certain delay time.

On the contrary, with respect to the line which follows the line immediately after the inversion of the polarity, the polarity of the gray scale voltage which is outputted to the drain signal lines (D) from the drain driver 130 is not changed, and, hence, the line readily assumes the level of the positive-polarity gray scale voltage. This phenomenon is also observed with respect to the case in which the polarity of the gray scale voltage outputted to the drain signal lines (D) is changed from the positive polarity to the negative polarity by the drain driver 130.

Accordingly, in spite of trying to display the same gray scales, the voltage written in the pixels on the line immediately after the inversion of the polarity and the voltage written in the pixels on the line which follows the line immediately after the inversion of the polarity differ from each other (the potential difference Vdif in FIG. 7), and, hence, the above-mentioned lateral stripes are formed for every 2 lines.

In this manner, the above-mentioned lateral stripes are formed due to the fact that the voltage which is written in the pixels on the line immediately after the polarity inversion and the voltage which is written in the pixels on the line which follows the line immediately after polarity inversion differ from each other.

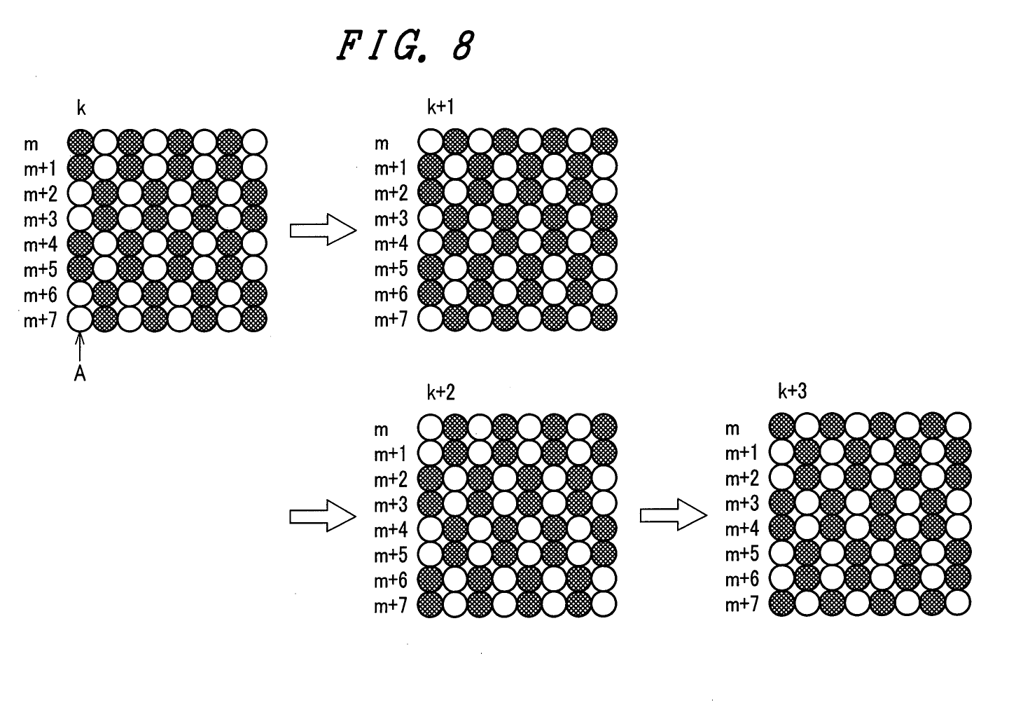

Accordingly, as shown in FIG. 8, the present invention is characterized in that the polarity inversion line position, where the polarity of the gray scale voltages is changed from the positive polarity to the negative polarity or from the negative polarity to the positive polarity, differs among the respective frames. Here, in FIG. 8, the positive-polarity gray scale voltage is expressed by a white dot and the negative-polarity gray scale voltage is expressed by a black dot.

For example, as shown in FIG. 8, with respect to an arbitrary m line in an arbitrary k frame, the negative-polarity gray scale voltage is written in the odd-numbered pixels and the positive-polarity gray scale voltage is written in the even-numbered pixels. In the same manner, also with respect to the (m+1) line, the negative-polarity gray scale voltage is supplied in the odd-numbered pixels and the positive-polarity gray scale voltage is supplied in the even-numbered pixels.

Further, with respect to the (m+2), (m+3) lines, the positive-polarity gray scale voltage is written in the odd-numbered pixels and the negative-polarity gray scale voltage is written in the even-numbered pixels.

Thereafter, in the same manner, in the respective pixels, the gray scale voltages whose polarities are inverted sequentially are written for every two lines.

In this k frame, the polarity inversion line position where the polarity of the gray scale voltage is changed from the positive polarity to the negative polarity exists in the m line and the (m+4) line, while the polarity inversion line position where the polarity of the gray scale voltage is changed from the negative polarity to the positive polarity exists in the (m+2) line and the (m+6) line.

Next, with respect to the m line in the (k+1) frame, the positive-polarity gray scale voltage is written in the odd-numbered pixels and the negative-polarity gray scale voltage is written in the even-numbered pixels. Further, with respect to the (m+1), (m+2) lines, the negative-polarity gray scale voltage is written in the odd-numbered pixels and the positive-polarity gray scale voltage is written in the even-numbered pixels. Thereafter, in the same manner, in the respective pixels, the gray scale voltages whose polarities are inverted sequentially are written for every two lines.

In this (k+1) frame, the polarity inversion line position, where the polarity of the gray scale voltage is changed from the positive polarity to the negative polarity, exists in the (m+1) line and the (m+5) line, while the polarity inversion line position, where the polarity of the gray scale voltage is changed from the negative polarity to the positive polarity, exists in the (m+3) line and the (m+7) line.

Next, with respect to the m, (m+1) lines in the (k+2) frame, the positive-polarity gray scale voltage is written in the odd-numbered pixels and the negative-polarity gray scale voltage is written in the even-numbered pixels. Further, with respect to the (m+2), (m+3) lines, the negative-polarity gray scale voltage is written in the odd-numbered pixels and the positive-polarity gray scale voltage is written in the even-numbered pixels. Thereafter, in the same manner, in the respective pixels, the gray scale voltages whose polarities are inverted sequentially are written for every two lines.

In this (k+2) frame, the polarity inversion line position, where the polarity of the gray scale voltage is changed from the positive polarity to the negative polarity, exists in the (m+2) line and the (m+6) line, while the polarity inversion line position, where the polarity of the gray scale voltage is changed from the negative polarity to the positive polarity, exists in the m line and the (m+4) line.

Next, with respect to the m line in the (k+3) frame, the negative-polarity gray scale voltage is written in the odd-numbered pixels and the positive-polarity gray scale voltage is written in the even-numbered pixels. Further, with respect to the (m+1), (m+2) lines, the positive-polarity gray scale voltage is written in the odd-numbered pixels and the negative-polarity gray scale voltage is written in the even-numbered pixels. Thereafter, in the same manner, in the respective pixels, the gray scale voltages whose polarities are inverted sequentially are written for every two lines.

In this (k+3) frame, the polarity inversion line position, where the polarity of the gray scale voltage is changed from the positive polarity to the negative polarity, exists in the (m+3) line and the (m+7) line, while the polarity inversion line position, where the polarity of the gray scale voltage is changed from the negative polarity to the positive polarity, exists in the (m+1) line and the (m+5) line.

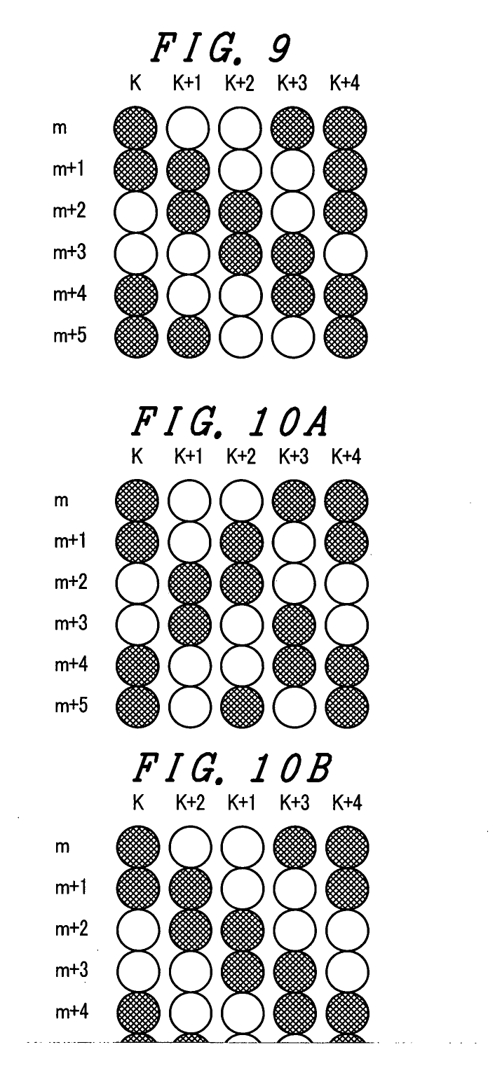

FIG. 9 is a view showing the polarities of the gray scale voltages which are written in the pixels in a column A in FIG. 8 in the sequentially continuous frames. Here, also in FIG. 9, the positive-polarity gray scale voltages are indicated by a white dot, while the negative-polarity gray scale voltages are indicated by a black dot.

As understood from FIG. 9, between the arbitrary k frame and the (k+4) frame which comes thereafter, the polarity inversion line position, where the polarity of the gray scale voltage is changed from the positive polarity to the negative polarity, is sequentially shifted from the m line to the (m+4) line, that is, in the order of the m line, the (m+1) line, the (m+2) line, the (m+3) line and the (m+4) line.

In the same manner, the polarity inversion line position, where the polarity of the gray scale voltage is changed from the negative polarity to the positive polarity, is sequentially shifted from the (m+2) line to the (m+5) line, that is, in the order of the (m+2) line, the (m+3) line, the (m+4) line and the (m+5) line.

In this manner, according to this embodiment, the polarity inversion line position, where the polarity of the gray scale voltage is changed from the positive polarity to the negative polarity or from the negative polarity to the positive polarity, is different among the respective frames, and, hence, the difference between or among the written voltages which are generated for respective lines is leveled, thus preventing the generation of the above-mentioned lateral stripes.

Here, assuming that the written voltage, when the polarity of the one-preceding-line gray scale voltage is the positive polarity and that of the present gray scale voltage is the positive polarity, is Va, that the written voltage, when the polarity of the one-preceding-line gray scale voltage is the negative polarity and that of the present gray scale voltage is the negative polarity, is Vb, that the written voltage, when the polarity of the one-preceding-line gray scale voltage is the positive polarity and that of the present gray scale voltage is the negative polarity, is Vc and the written voltage, when the polarity of the one-preceding-line gray scale voltage is the negative polarity and that of the present gray scale voltage is the positive polarity, is Vd, it is understood that the pixel in the (m+1) line shown in FIG. 9 assumes the voltage Vb in the k frame, the voltage Vc in the (k+1) frame, the voltage Va in the (k+2) frame and the voltage Vd in the (k+3) frame.

Accordingly, with respect to the pixels in the (m+1) line shown in FIG. 9, the sum of the written voltages becomes (Va+Vb+Vc+Vd) within the continuous four frames from the k frame to the (k+3) frame. The sum of the written voltages becomes (Va+Vb+Vc+Vd) also with respect to the pixels in other lines. Accordingly, the written voltages for the respective pixels within the continuous four frames become uniform.

Accordingly, in this embodiment, the generation of the above-mentioned lateral stripes can be prevented, whereby it is possible to provide a liquid crystal display panel which exhibits a low power consumption and a high image quality.

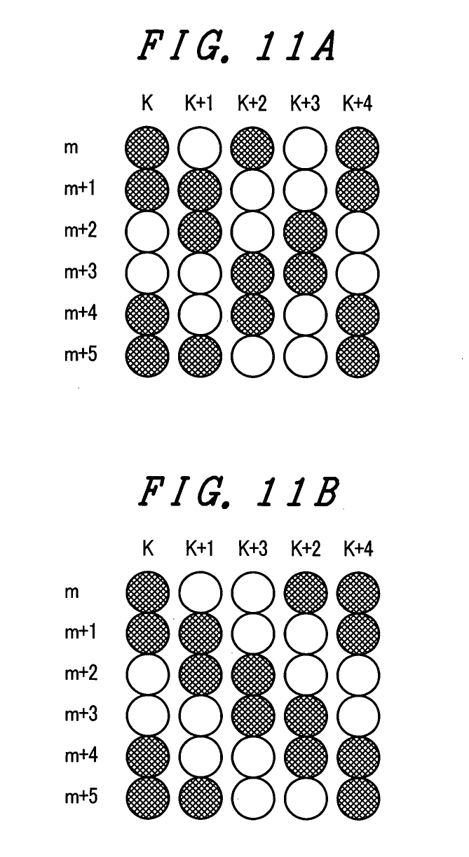

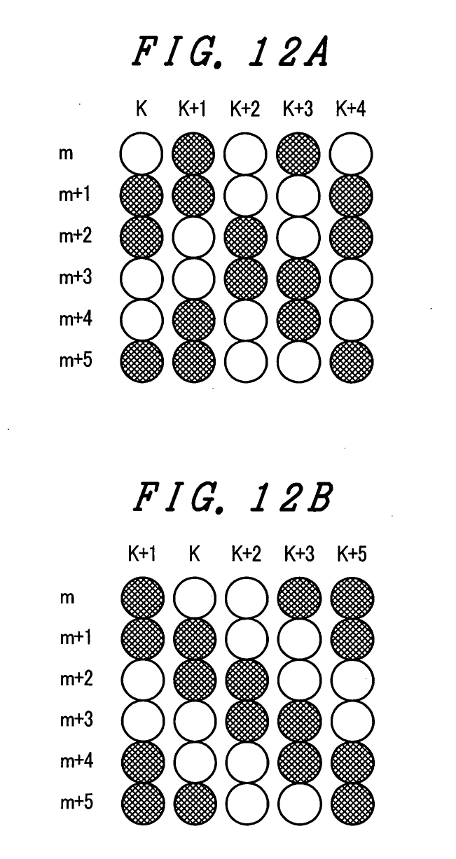

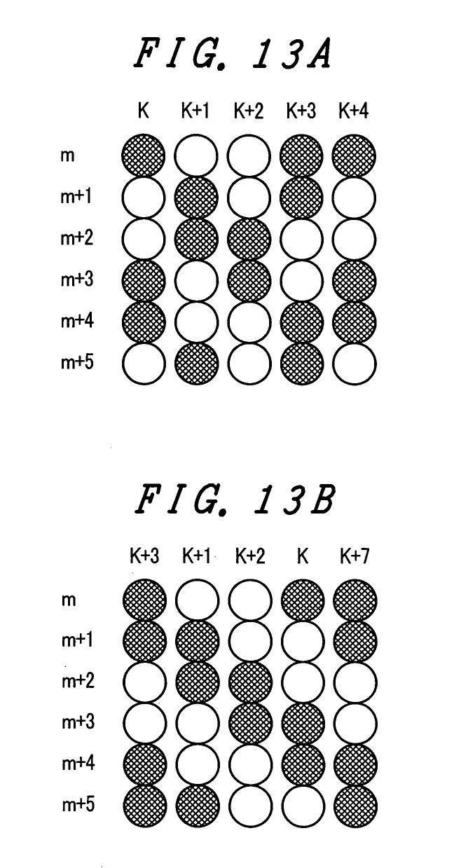

With respect to the patterns of the polarity inversion line position where the polarity of the gray scale voltage is changed from the positive polarity to the negative polarity or from the negative polarity to the positive polarity in the respective frames, patterns shown in FIG. 10A to FIG. 14A are considered besides the pattern shown in FIG. 9.

FIG. 10A to FIG. 14A, in the same manner as FIG. 9, are views showing the polarities of the gray scale voltages which are written in the pixels in the column A shown in FIG. 8 within the sequentially continuous frames. Also, with respect to the patterns shown in FIG. 10A to FIG. 14A, the generation of the above-mentioned lateral stripes can be prevented.

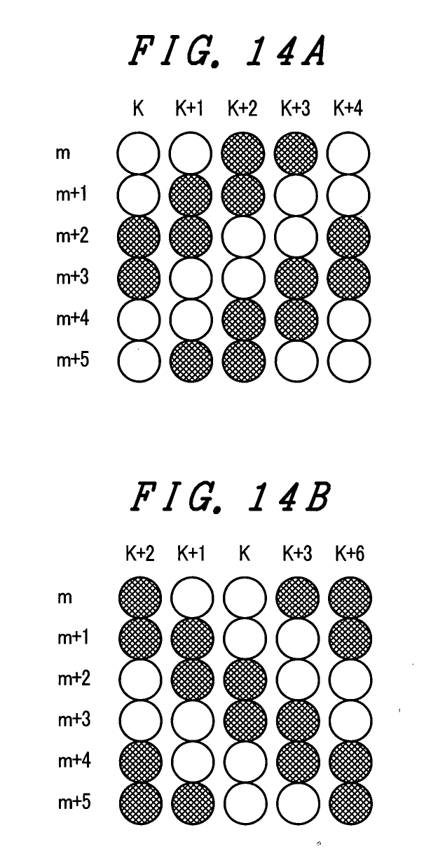

Here, in the patterns shown in FIG. 9, FIG. 14A, there may be a case in which the lateral stripes are observed in a state in which the lateral stripes are scrolled from the top to the bottom of the screen or from the bottom to the top of the screen. However, in the patterns shown in FIG. 10A to FIG. 13A, it is possible to prevent the case in which the lateral stripes are observed in a state in which the lateral stripes are scrolled from the top to the bottom of the screen or from the bottom to the top of the screen.

Further, as shown in FIG. 10B to FIG. 14B, with respect to the pattern shown in FIG. 10A to FIG. 14A, by replacing two frames in the frames ranging from the k frame to the (k+3) frame, the pattern becomes equal to the pattern shown in FIG. 9.

Here, in the above-mentioned explanation, an example is given with respect to the case in which the polarities of the gray scale voltages applied to the drain signal lines (D) from the drain driver 130 are inverted for every 2 lines. However, the present invention is not limited to such a case, and the polarities of the gray scale voltages that are applied to the drain signal lines (D) from the drain driver 130 may be inverted for every N lines (N≧2).

In this case, the voltages which are written in the respective pixels are uniform within continuous 2N frames from the arbitrary k frame to the (k+(2×N−1)) frame.

As described above, the switching part (1) 262 and the switching parts (2) 264 shown in FIG. 5 are controlled in response to the AC signals (M). That is, the polarities of the gray scale voltages applied to the drain signal lines (D) from the drain driver 130 are controlled in response to the AC signals (M).

For example, in the above-mentioned pattern shown in FIG. 9, the gray scale voltages assume the positive polarity (in the case of white dots shown in FIG. 9) when the AC signal (M) is at the High-level, and the gray scale voltages assume the negative polarity (in the case of black dots shown in FIG. 9) when the AC signal (M) is at the Low-level.

Accordingly, by adjusting the cycle of the AC signal (M) or the rising position or the falling position of the AC signal (M), as in the cases of the above-mentioned patterns shown in FIG. 9 to FIG. 14A, it is possible to make the polarity inversion line positions, at which the polarities of the gray scale voltages are changed from the positive polarity to the negative polarity or from the negative polarity to the positive polarity, differ among the respective frames.

Hereinafter, an example of the circuit constitution for generating the AC signals (M) will be explained.

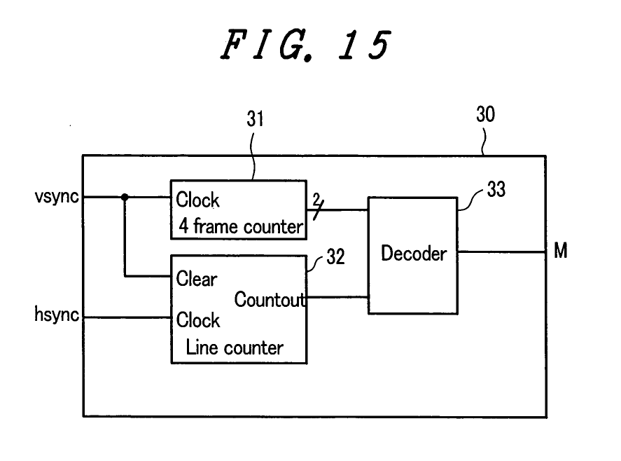

FIG. 15 is a block diagram showing the circuit constitution of an AC signal generating circuit for generating the AC signal (M) of this embodiment.

Here, the AC signal generating circuit 30 shown in FIG. 15 has a circuit constitution in which the polarities of the gray scale voltages applied to the drain signal lines from the drain driver 130 are inverted for every 2 lines (N=2). Further, the AC signal generating circuit 30 shown in FIG. 15 is provided in the inside of the display control means 110 shown in FIG. 1.

The AC signal generating circuit 30 shown in FIG. 15 includes a 4-frame counter 31, a line counter 32 and a decoding circuit 33, wherein the 4-frame counter 31 counts vertical synchronizing signals (Vsync) and the line counter 32 counts the horizontal synchronizing signals (Hsync). Outputs of the 4-frame counter 31 and the line counter 32 are inputted to the decoding circuit 33, and the AC signals (M) are outputted from the decoding circuit 33.

Here, the 4-frame counter 31 is reset each time the four vertical synchronizing signals (Vsync) are counted. On the other hand, the line counter 32 is reset in response to the vertical synchronizing signal (Vsync).

Here, although an explanation has been given with respect to an embodiment in which the present invention is applied to a vertical-electric-field type liquid crystal display panel, the present invention is not limited to such a case. That is, the present invention is also applicable to an in-plane-electric-field type liquid crystal display panel.

Further, the present invention is also applicable to a twofold driving method in which one frame is divided into two fields and the liquid crystal display device is subjected to twofold driving.

Although the present invention has been specifically described in conjunction with the above-mentioned embodiments, it is needless to say that the present invention is not limited to the above-mentioned embodiments, and various modifications can be made without departing from the gist of the present invention.

1. A method of driving a liquid crystal display device which includes a plurality of pixels and a plurality of video lines which apply a gray scale voltage to the plurality of pixels, and in which the polarity of the gray scale voltage which is supplied to the respective video lines for every N (N≧2) lines, is inverted, wherein
a polarity inversion line position at which the polarity of the gray scale voltage is changed from the positive polarity to the negative polarity or from the negative polarity to the positive polarity is different among respective frames.

2. A driving method of a liquid crystal display device according to claim 1, wherein between continuous frames, the polarity inversion line position is discontinuous.

3. A driving method according to claim 1 or claim 2, wherein between continuous 2N frames, the positive-polarity gray scale voltage and the negative-polarity gray scale voltage are supplied (N/2) times for each pixel.

4. A driving method of a liquid crystal display device according to claim 3, wherein N is 2.

5. A liquid crystal display device comprising:
a plurality of pixels;
a plurality of video lines which apply a gray scale voltage to the plurality of pixels; and
a drive circuit which supplies the gray scale voltage to the plurality of video lines, wherein
the drive circuit inverts the polarity of the gray scale voltage which is supplied to the respective video lines for every N (N≧2) lines, and
the drive circuit operates such that a polarity inversion line position, at which the polarity of the gray scale voltage is changed from the positive polarity to the negative polarity or from the negative polarity to the positive polarity, is different among respective frames.

6. A liquid crystal display device according to claim 5, wherein the liquid crystal display device includes a display control circuit which outputs an AC signal to the drive circuit, and the drive circuit inverts the polarity of the gray scale voltage to be supplied to the respective video lines for every N(N≧2) lines based on the AC signal outputted from the display control circuit.

7. A liquid crystal display device according to claim 5 or claim 6, wherein the drive circuit operates such that the polarity inversion line position is discontinuous between the continuous frames.

8. A liquid crystal display device according to claim 7, wherein the drive circuit, between continuous 2N frames, supplies the positive-polarity gray scale voltage and the negative-polarity gray scale voltage for every (N/2) times.

9. A liquid crystal display device according to claim 8, wherein N is 2.
